(19) United States
(12) Patent Application Publication
(10) Pub. No.: US 2016/0147907 A1
(43) Pub. Date: May 26, 2016

(54) METHOD AND CAD SYSTEM FOR VERIFYING DESIGN CHANGES OF COMPONENTS BASED ON CAD PLATFORM

(71) Applicants: INVENTEC (PUDONG) TECHNOLOGY CORPORATION, Shanghai (CN); INVENTEC CORPORATION, Taipei City (TW)

(72) Inventors: CHUNG-SHENG NI, Taipei City (TW); CHIH-PIN WEI, Taipei City (TW); CHUN-YING YANG, Taipei City (TW); CHANG-HSIN CHIU, Taipei City (TW)

(21) Appl. No.: 14/684,446

(22) Filed: Apr. 13, 2015

(30) Foreign Application Priority Data
Nov. 26, 2014 (CN) 201410696698.5

(51) Int. Cl. G06F 17/50

(52) U.S. Cl. CPC G06F 17/50

(57) ABSTRACT

A method for verifying design changes of components based on a CAD platform is utilized to graphically show differences between previous and current versions of a 3D component. The method includes the following steps performed by a computer: sequentially comparing a plurality of design features of the previous and current versions of the 3D component; distinguishing a feature difference and showing it in a list on a page; altering a filename of the previous version; assembling the 3D component of the previous version whose filename is altered and the 3D component of the current versions in a single assembly to form a 3D drawing; and generating a link corresponding to the feature difference, so that the corresponding feature can be displayed on the 3D drawing when clicking on the feature difference on the page. A CAD system is also provided.

### TECHNICAL FIELD OF THE INVENTION

The present invention relates to a method and CAD (Computer-Aided Design, CAD) system based on a CAD platform, and in particular to a method and CAD system for verifying design changes of components based on the CAD platform.

### BACKGROUND OF THE INVENTION

In the technical field of R&D and design of electronic products, the design for electronic circuits and shapes of mechanisms is an important link. In recent years, since integrated circuit process technology and complexity of the electronic product design have been rising, CAD systems need to be employed in the design of the electronic circuits, the shapes of mechanisms and the like.

With increasingly fierce competition in the electronic products, working hours for three-dimensional (3D) part design of the electronic products are increasingly urgent. Consequently, plural design teams to synchronously design or customers to collaboratively design one product are common.

However, prior art CAD tools are unable to verify differences between current and previous versions of the parts in a 3D model file. Furthermore, the parts of the electronic products nowadays are numerous and complex, so a lot of time has to be spent on comparing the differences of the part designs by manual labor. This is neither accurate nor in accord with work efficiency.

### SUMMARY OF THE INVENTION

Accordingly, an objective of the present invention is to provide a method for verifying design changes of components based on a CAD platform, being able to graphically show differences between a previous version and a current version of a 3D component for avoiding excessive mold modifications and high product development costs due to design mistakes, thereby overcoming the inconvenience of the collaborative design in the prior.

Another objective of the present invention is to provide a CAD system for verifying design changes of components, able to graphically show differences between a previous version and a current version of a 3D component for correctly grasp the design changes of components, thereby accelerating the effectiveness and correctness of an offer for the products by the manufacturers.

To achieve the foregoing objectives, the method for verifying design changes of components based on a CAD platform provided in the present invention is utilized to graphically show differences between a previous version and a current version of a 3D component. The method includes the following steps performed by a computer: sequentially comparing a plurality of design features of the previous version and the current version of the 3D component; distinguishing a feature difference and showing it in a list on a page; altering a filename of the previous version; assembling the 3D component of the previous version whose filename is altered and the 3D component of the current versions in a single assembly, so as to form a 3D drawing; and generating a link corresponding to the feature difference on the 3D drawing, so that the corresponding feature can be displayed on the 3D drawing when clicking on the feature difference on the page.

In one preferred embodiment, the feature difference includes an addition, deletion, or modification. Moreover, the page includes a corresponding icon which is utilized to indicate the feature difference to be the addition, deletion, or modification. Preferably, the corresponding icon is a hyperlink, and the hyperlink is coupled to the corresponding feature on the 3D drawing.

In one preferred embodiment, the 3D drawing includes the 3D component of the previous version and the 3D component of the current version, and both are displayed side by side. Preferably, a color of the 3D component of the previous version differs from that of the 3D component of the current version.

In one preferred embodiment, when clicking on the feature difference on the page, the 3D drawing shows an indicator corresponding to the feature difference.

To achieve the another objective mentioned above, the CAD system for verifying design changes of components provided in the present invention is able to graphically show differences between a previous version and a current version of a 3D component. The CAD system includes a comparing unit, a distinguishing unit, a renaming unit, an assembling unit, and a link generating unit. The comparing unit is utilized to sequentially compare a plurality of design features of the previous version and the current version of the 3D component. The distinguishing unit is utilized to distinguish a feature difference and showing it in a list on a page. The renaming unit is utilized to alter a filename of the previous version. The assembling unit is utilized to assemble the 3D component of the previous version whose filename is altered and the 3D component of the current versions in a single assembly, so as to form a 3D drawing. The link generating unit generates a link corresponding to the feature difference on the 3D drawing so that the corresponding feature can be displayed on the 3D drawing when clicking on the feature difference on the page.

In one preferred embodiment, the feature difference comprises an addition, deletion, or modification.

In one preferred embodiment, the 3D drawing includes the 3D component of the previous version and the 3D component of the current version, and both are displayed side by side.

In comparison with the prior art, the method and the CAD system for verifying the design changes of the components according to the present invention are capable of distinguishing the feature difference and showing it in a list on the page. Moreover, the 3D drawing displays the current and previous versions side by side, so that which components to be changed in the current and previous versions of the model can be quickly verified when there are two design teams to synchronously design. Accordingly, the designers can clearly grasp the changed components alteration, so as to continue designing based on the design results of a previous team.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a flow chart illustrating a method for verifying design changes of components based on a CAD platform according to one preferred embodiment of the present invention;

FIG. 2 is a schematic drawing illustrating part lists of a previous model and a current model according to the preferred embodiment;

FIG. 3 is a schematic drawing illustrating lists of feature libraries of the previous version and the current version of the 3D component;

FIG. 4 is a schematic drawing illustrating a page according to the preferred embodiment;

FIG. 5 is a perspective view illustrating a 3D drawing according to of the embodiment; and

FIG. 6 is a block diagram illustrating a CAD system for verifying design changes of components according to a preferred embodiment of the present invention.

### DETAILED DESCRIPTION OF THE INVENTION

The present invention will now be described in detail with reference to a few preferred embodiments thereof as illustrated in the accompanying drawings. The same reference numerals refer to the same parts or like parts throughout the various figures.

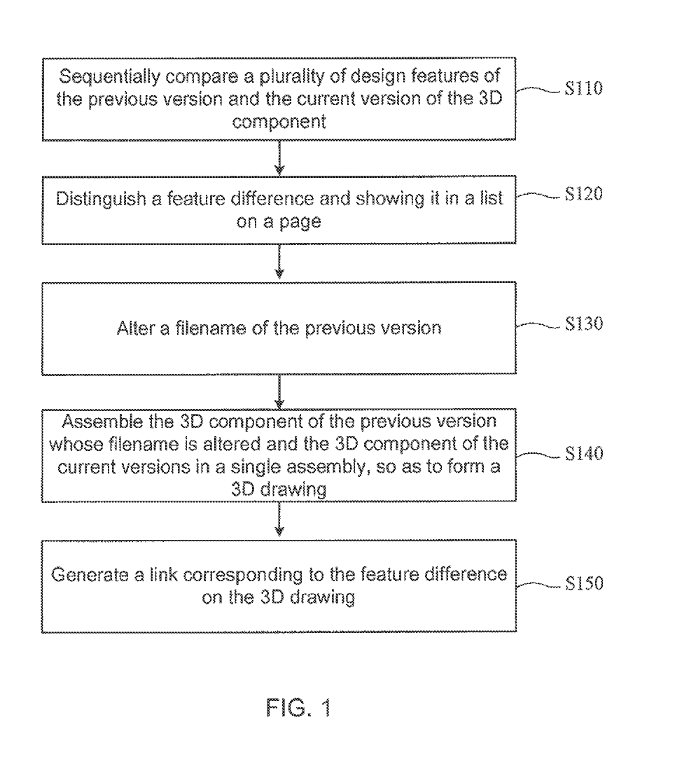

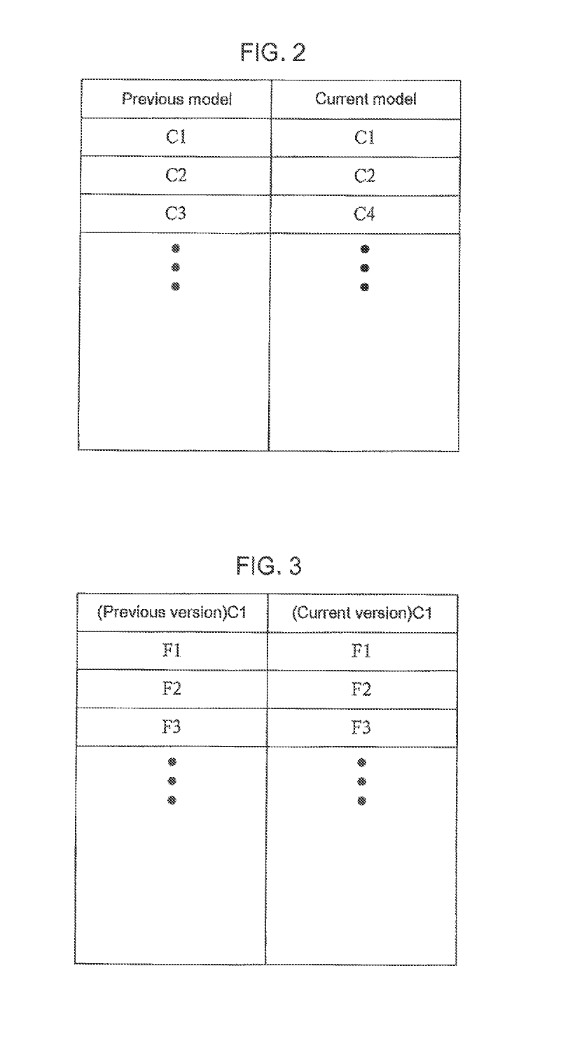

The following will illustrate a method for verifying design changes of components based on a CAD platform according to one preferred embodiment in detail with drawings. Referring to FIG. 1 and FIG. 2, FIG. 1 is a flow chart illustrating a method for verifying design changes of components based on a CAD platform according to one preferred embodiment of the present invention; FIG. 2 is a schematic drawing illustrating part lists of a previous model and a current model according to the preferred embodiment. The method is utilized to graphically show differences between a previous version and a current version of a 3D component.

The method of the embodiment includes step S110 to step S150 performed by a computer. As shown in FIG. 2, before performing the above steps, the method will take out 3D components whose filenames are identical to a previous model (assembly model) and a current model. In the embodiment, the filenames of the 3D components of the previous model include C1, C2, C3 . . . , the filenames of the 3D components of the previous model include C1, C2, C4 . . . . Therefore, in this prior step, determining design changes of the 3D component C1 will be first executed.

In step S110, a plurality of design features of the previous version and the current version of the 3D component C1 are sequentially compared, and then execution resumes at step S120. Referring to FIG. 3 with the above, FIG. 3 is a schematic drawing illustrating lists of feature libraries of the previous version and the current version of the 3D component C1. In this example, design features of the previous version of the 3D component C1 have F1, F2, F3 . . . ; design features of the current version of the 3D component C1 have F1, F2, F3 . . . , where the above-mentioned design features can be geometry, size and other parameters which constitute the component. It is worth mentioning that the sequentially comparing of step S110 begins to compare the design features F1 of the previous version and the design features F1 of the current version. After the comparison, then the step compares the design features F2 of the previous version and the design features F2 of the current version, and the rest may be deduced by analogy.

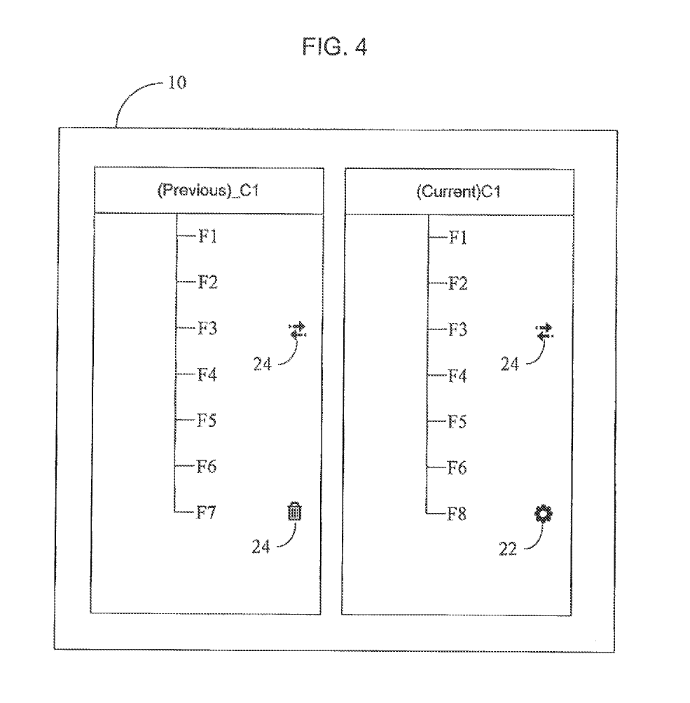

In step S120, a feature difference is distinguished, and it is shown in a list on a page, and then execution resumes at step S130. Referring to FIG. 4 with the above, FIG. 4 is a schematic drawing illustrating a page according to the preferred embodiment. After the sequentially comparing of said step, a comparison chart is established on a page 10. That is, the design features F1 to F7 of the 3D component C1 in the previous version and the design features F1 to F8 of the 3D component C1 in the current version are indicated. More specifically, the feature difference includes an addition, deletion, or modification. In this example, the feature difference includes the design features F3 and F7 of the 3D component C1 in the previous version, and the design features F3 and F8 of the 3D component C1 in the current version. It is worth mentioning that the page 10 can be presented as a form of Web pages.

Specifically, the page 10 includes a corresponding icon which is utilized to indicate the feature difference to be the addition, deletion, or modification, i.e. an addition icon 22, a deletion icon 24, and a modification icon 26. More specifically, in step S120, the difference between the size parameter of the design features F3 of the 3D component C1 in the previous version and the size parameter of the design features F3 of the 3D component C1 in the current version is distinguished. Thus, the modification icon 26 is shown respectively beside the design features F3 of the 3D component C1 in the previous version and the design features F3 of the 3D component C1 in the current version. In addition, in step S120, the design features F7 of the 3D component C1 in the previous version no longer existing in the design features of the 3D component C1 in the current version is distinguished, so the deletion icon 24 is shown beside the design features F7 of the 3D component C1 in the previous version. Similarly, in step S120, the design features F8 of the 3D component C1 in the current version no longer existing in the design features of the 3D component C1 in the previous version is distinguished, so the addition icon 22 is shown beside the design features F8 of the 3D component C1 in the current version.

In step S130, a filename of the previous version is altered, and then execution resumes at step S140. In this example, the filename of the 3D component in the previous version has been altered as _C1. That is, a bottom line is added in front of the original filename, as shown on the page 10 of FIG. 4. However, the present invention is not restricted thereto.

In step S140, the 3D component _C1 of the previous version whose filename is altered and the 3D component C1 of the current versions are assembled in a single assembly, so as to form a 3D drawing, and then execution resumes at step S150. Specifically, the 3D component C1 of the previous version whose filename is altered can be distinguished from the 3D component C1 of the current version in the CAD system, so both can be assembled in one assembly.

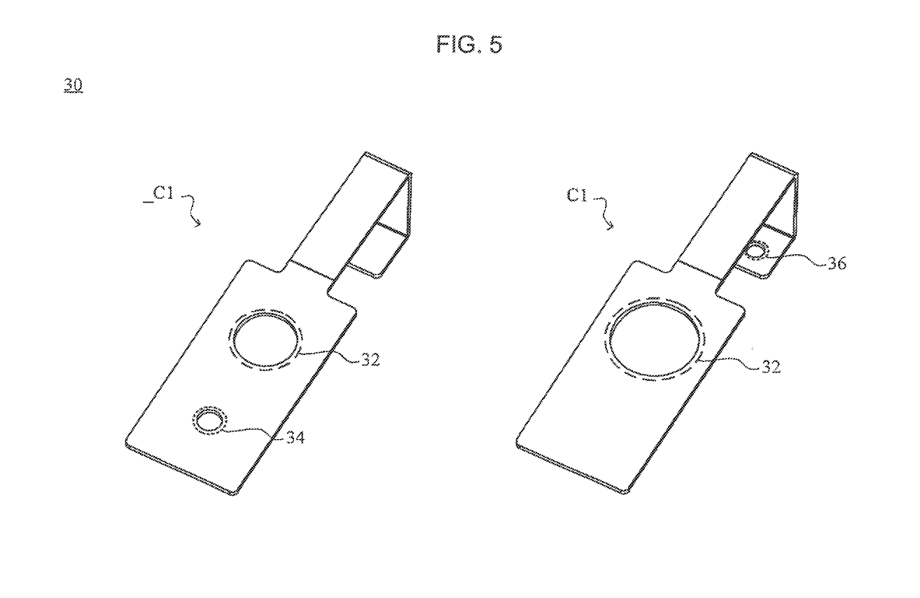

Referring to FIG. 5, FIG. 5 is a perspective view illustrating a 3D drawing according to of the embodiment. The 3D drawing 30 includes the 3D component C1 of the previous version and the 3D component C1 of the current version, and both are displayed side by side. In order to display clearly, a color of the 3D component _C1 of the previous version differs from that of the 3D component C1 of the current version. In the embodiment, the color of the 3D component _C1 of the previous version is green, and the color of the 3D component C1 of the current version is yellow. However, the present invention is not restricted thereto.

In step S150, a link corresponding to the feature difference on the 3D drawing is generated, so that the corresponding feature can be displayed on the 3D drawing 30 when clicking on the feature difference on the page 10. Specifically, the corresponding icon on the page 10 is a hyperlink, and the hyperlink is coupled to the corresponding feature on the 3D drawing 30.

When a user clicks on the feature difference (i.e. the hyperlink), the 3D drawing 30 shows an indicator corresponding to the feature difference. For example, as shown in FIG. 5, when the modification icon 26 of the design features F3 of the 3D component C1 of the previous version or the design features F3 of 3D component C1 of the current version are clicked on, the 3D drawing 30 shows an indicator 32, which can be a blinking dotted line shown around the outline of the feature. When the deletion icon 24 of the design features F7 of the 3D component C1 of the previous version are clicked on, the 3D drawing 30 shows an indicator 34. Similarly, when the addition icon 22 of the design features F8 of the 3D component C1 of the current version are clicked on, the 3D drawing 30 shows an indicator 36. It is worth mentioning that the present invention does not limit specific types to represent the indicator. It can also be implemented by using a color change or other types beneficial to the user to distinguish.

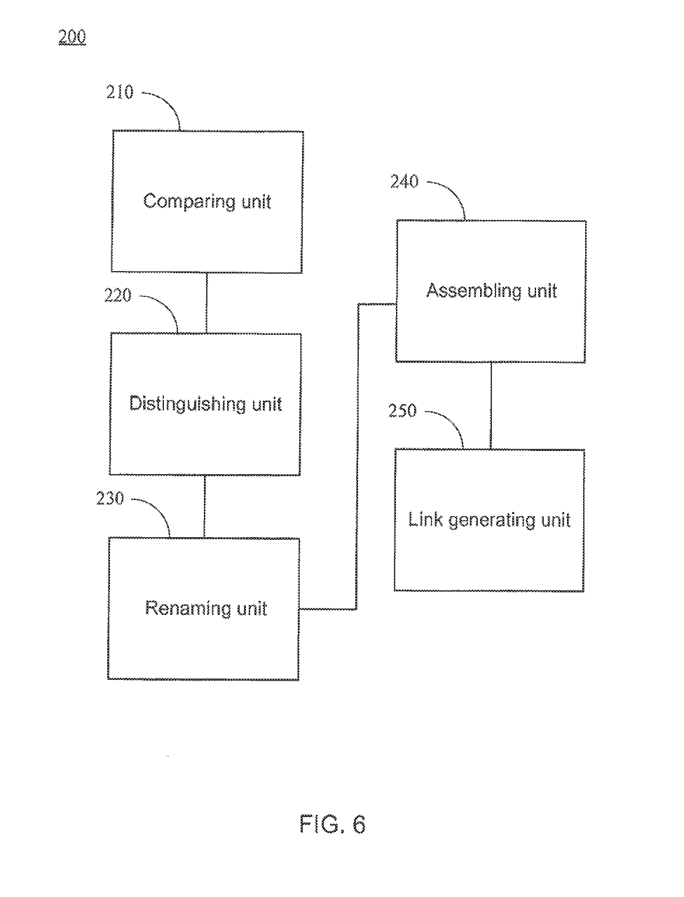

What follows is a detail of the specific structure for realizing the above-mentioned method for verifying design changes of components. Referring to FIG. 6, FIG. 6 is a block diagram illustrating a CAD system for verifying design changes of components according to a preferred embodiment of the present invention. A CAD system 200 for verifying design changes of components according to the embodiment is utilized to embody the above-mentioned method for verifying design changes of components, and the descriptions of the following elements have been explained as above mention, so no further detail will be provided herein. The CAD system for verifying design changes of components according to the embodiment is capable of graphically showing differences between a previous version and a current version of a 3D component. The CAD system includes a comparing unit 210, a distinguishing unit 220, a renaming unit 230, an assembling unit 240, and a link generating unit 250.

Referring to FIGS. 1 to 6, the comparing unit 210 is utilized to sequentially compare a plurality of design features of the previous version and the current version of the 3D component C1. The distinguishing unit 220 is utilized to distinguish the feature difference and showing it in a list on the page 10. The renaming unit 230 is utilized to alter the filename of the previous version. The assembling unit 240 is utilized to assemble the 3D component _C1 of the previous version whose filename is altered and the 3D component C1 of the current versions in a single assembly, so as to form the 3D drawing 30. The link generating unit 250 generates the link corresponding to the feature difference on the 3D drawing 30, so that the corresponding feature can be indicated on the 3D drawing 30 when clicking on the feature difference on the page 10.

Similarly, the feature difference includes an addition, deletion, or modification, i.e. the addition icon 22, deletion icon 24, and modification icon 26 as shown in FIG. 4. In addition, the 3D drawing 30 includes the 3D component _C1 of the previous version and the 3D component C1 of the current version, and both are displayed side by side. The details of the above can be directed to the above-mentioned descriptions, so no further detail will be provided herein.

The described techniques of the steps or CAD system may be implemented in hardware, software, firmware, or any combination thereof. If they are implemented in software, the software may be executed in a processor, which may refer to one or more processors, such as a microprocessor, application specific integrated circuit (ASIC), field programmable gate array (FPGA), or digital signal processor (DSP), or other equivalent integrated or discrete logic circuitry. Software comprising instructions to execute the techniques may be initially stored in a computer-readable medium and loaded and executed by a processor.

In summary, the method and the CAD system 200 for verifying the design changes of the components according to the present invention are capable of distinguishing the feature difference and showing it in a list on the page 10. Moreover, the 3D drawing displays the current and previous versions side by side, so that which components to be changed in the current and previous versions of the model can be quickly verified when there are two design teams to synchronously design. Accordingly, the designers can clearly grasp the changed components alteration, so as to continue designing based on the design results of a previous team.

While the preferred embodiments of the present invention have been illustrated and described in detail, various modifications and alterations can be made by persons skilled in this art. The embodiment of the present invention is therefore described in an illustrative but not restrictive sense.

What is claimed is:

1. A method for verifying design changes of components based on a computer-aided design (CAD) platform, utilized to graphically show differences between a previous version and a current version of a three-dimensional (3D) component, the method comprising the following steps performed by a computer:
sequentially comparing a plurality of design features of the previous version and the current version of the 3D component;
distinguishing a feature difference and showing it in a list on a page;
altering a filename of the previous version;
assembling the 3D component of the previous version whose filename is altered and the 3D component of the current versions in a single assembly, so as to form a 3D drawing; and
generating a link corresponding to the feature difference on the 3D drawing, so that the corresponding feature can be displayed on the 3D drawing when clicking on the feature difference on the page.

2. The method of claim 1, wherein the feature difference comprises an addition, deletion, or modification.

3. The method of claim 2, wherein the page comprises a corresponding icon which is utilized to indicate the feature difference to be the addition, deletion, or modification.

4. The method of claim 3, wherein the corresponding icon is a hyperlink, and the hyperlink is coupled to the corresponding feature on the 3D drawing.

5. The method of claim 1, wherein the 3D drawing comprises the 3D component of the previous version and the 3D component of the current version, and both are displayed side by side.

6. The method of claim 5, wherein a color of the 3D component of the previous version differs from that of the 3D component of the current version.

7. The method of claim 1, wherein when clicking on the feature difference on the page, the 3D drawing shows an indicator corresponding to the feature difference.

8. A CAD system for verifying design changes of components, utilized to graphically show differences between a previous version and a current version of a 3D component, the CAD system comprising:
a comparing unit utilized to sequentially compare a plurality of design features of the previous version and the current version of the 3D component;
a distinguishing unit utilized to distinguish a feature difference and showing it in a list on a page;
a renaming unit utilized to alter a filename of the previous version thereof;
an assembling unit utilized to assemble the 3D component of the previous version whose filename is altered and the 3D component of the current versions in a single assembly, so as to form a 3D drawing; and
a link generating unit for generating a link corresponding to the feature difference on the 3D drawing, so that the corresponding feature can be displayed on the 3D drawing when clicking on the feature difference on the page.

9. The CAD system of claim 8, wherein the feature difference comprises an addition, deletion, or modification.

10. The CAD system of claim 9, wherein the page comprises a corresponding icon which is utilized to indicate the feature difference to be the addition, deletion, or modification.

11. The CAD system of claim 10, wherein the corresponding icon is a hyperlink, and the hyperlink is coupled to the corresponding feature on the 3D drawing.

12. The CAD system of claim 8, wherein the 3D drawing comprises the 3D component of the previous version and the 3D component of the current version, and both are displayed side by side.

13. The CAD system method of claim 12, wherein a color of the 3D component of the previous version differs from that of the 3D component of the current version.

14. A computer-readable medium comprising computer-executable instructions for performing a method for verifying design changes of components based on a CAD platform, utilized to graphically show differences between a previous version and a current version of a 3D component, the method comprising the following steps:
sequentially comparing a plurality of design features of the previous version and the current version of the 3D component;
distinguishing a feature difference and showing it in a list on a page;
altering a filename of the previous version;
assembling the 3D component of the previous version whose filename is altered and the 3D component of the current versions in a single assembly, so as to form a 3D drawing; and
generating a link corresponding to the feature difference on the 3D drawing, so that the corresponding feature can be displayed on the 3D drawing when clicking on the feature difference on the page.

15. The computer-readable medium of claim 14, wherein the feature difference comprises an addition, deletion, or modification.

16. The computer-readable medium of claim 15, wherein the page comprises a corresponding icon which is utilized to indicate the feature difference to be the addition, deletion, or modification.

17. The computer-readable medium of claim 16, wherein the corresponding icon is a hyperlink, and the hyperlink is coupled to the corresponding feature on the 3D drawing.

18. The computer-readable medium of claim 14, wherein the 3D drawing comprises the 3D component of the previous version and the 3D component of the current version, and both are displayed side by side.

19. The computer-readable medium of claim 18, wherein a color of the 3D component of the previous version differs from that of the 3D component of the current version.

20. The computer-readable medium of claim 14, wherein when clicking on the feature difference on the page, the 3D drawing shows an indicator corresponding to the feature difference.
